(19) United States
(12) Patent Application Publication
(10) Pub. No.: US 2016/0116089 A1
(43) Pub. Date: Apr. 28, 2016

(54) DRYER DOCKING STATION

(71) Applicant: Rex Lewis, Adrian, MI (US)

(72) Inventor: Rex Lewis, Adrian, MI (US)

(21) Appl. No.: 14/522,691

(22) Filed: Oct. 24, 2014

(51) Int. Cl. F16L 21/00; F16L 21/03

(52) U.S. Cl. CPC F16L 21/00; F16L 21/03

(57) ABSTRACT

A dryer docking apparatus having a frame adapted to be positioned against the wall behind a clothes dryer. A vent port carrier is adjustably secured to the frame in both the vertical and horizontal positions so that the vent port is aligned with the air outlet from the clothes dryer. A conventional vent pipe is connected to the vent port carrier to exhaust the air outlet from the clothes dryer.

### BACKGROUND OF THE INVENTION

I. FIELD OF THE INVENTION

The present invention relates to a dryer docking apparatus for a residential clothes dryer.

II. DESCRIPTION OF RELATED ART

Most residential clothes dryers include a 4 inch outlet pipe for exhausting air from the dryer. Typically, the outlet pipe from the dryer is mounted near the bottom of the dryer, although the precise location of the outlet pipe varies between different dryers. This exhaust pipe is then connected through a vent pipe to a vent which is usually open outside of the home. The vent pipe between the exterior vent and the dryer may be either rigid piping or flexible piping.

In order to clean behind the dryer, it is usually necessary to pull the dryer away from the wall which results in disconnection of the vent piping from the dryer. After the area behind the dryer has been cleaned, it is necessary to reconnect the vent pipe to the dryer and then push the dryer towards the wall while still leaving sufficient room behind the dryer for the vent pipe. Unfortunately, in many situations, the vent pipe becomes damaged when the dryer is pushed against the wall and against the vent pipe. This, in turn, can result in insufficient or restricted airflow through the vent pipe resulting in an accumulation of lint. Such lint accumulation forms a fire hazard.

A still further problem with the previously known dryers is that it is relatively difficult to detach and reattach the vent pipe from the dryer each time the dryer is retracted from the wall.

Furthermore, if the vent pipe is improperly attached to the dryer, the exhaust from the dryer with its entrained lint is expelled into the laundry area.

### SUMMARY OF THE PRESENT INVENTION

The present invention provides a docking station for a laundry dryer which overcomes the above mentioned disadvantages of the previously known devices.

In brief, the docking station or apparatus of the present invention includes a frame having both a front portion and a rear portion. Both the front and rear portions are formed by interconnected struts of a rigid material, such as steel, plastic, or the like.

The front portion and rear portion of the frame are interconnected but are spaced apart from each other by a distance equal to or greater than the diameter of the vent pipe from the dryer. Typically, vent dryer pipes are 4 inches in diameter so that the spacing between the front portion of the frame and the rear portion of the frame is substantially equal to 4 inches. Thus, with the vent pipe extending through the interior of the frame, the vent pipe is contained completely within the interior of the frame.

A vent port carrier is attached to the end of the vent pipe within the laundry room. This vent port carrier is, in turn, adjustably secured to the frame by a pair of cross members. The cross members are vertically adjustable relative to the frame and, similarly, the vent port carrier is horizontally adjustable relative to the cross bars. Consequently, the vent port carrier, and thus the vent opening for the vent pipe, are adjustable so that the vent port for the vent pipe is accurately aligned with the air outlet from the dryer. When in its adjusted position, the vent port carrier is secured to the cross bars by a threaded fastener or other mechanism and, similarly, the cross bars are secured to the frame by a threaded fastener or other mechanism thus locking the vent port in its adjusted position.

Since the vent port for the vent pipe is aligned with the air outlet from the dryer, the dryer may be easily pulled away from the vent pipe for cleaning or other access behind the dryer. The dryer may subsequently be returned to its original position and, in doing so, the air outlet from the dryer and port for the vent pipe are automatically aligned with each other and connected together as the dryer is pushed against the frame.

Furthermore, since the vent pipe is contained within the interior of the frame, the frame effectively prevents the dryer from crushing the vent pipe as the dryer is returned to its original in-use position.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is an elevational view illustrating a preferred embodiment of the present invention; and

FIG. 2 is a sectional view taken substantially along line 2-2 in FIG. 1 and enlarged for clarity.

FIG. 3 is a view similar to FIG. 2, but slowing the dryer outlet in a connected position.

### DETAILED DESCRIPTION OF A PREFERRED EMBODIMENT OF THE PRESENT INVENTION

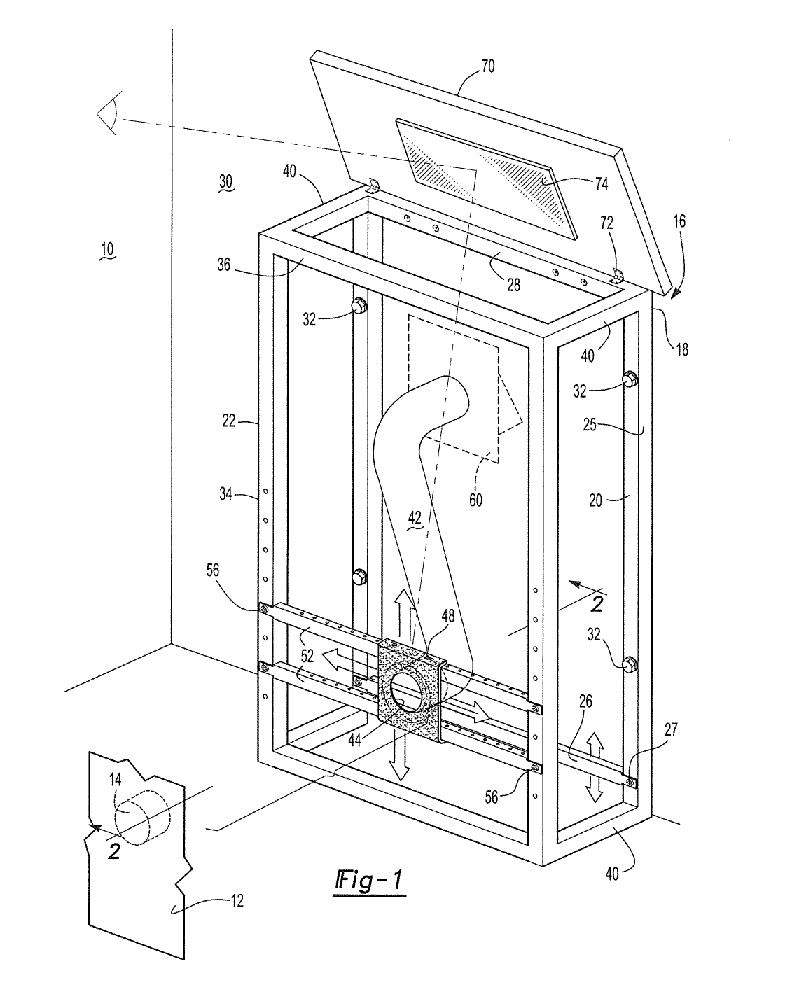

With reference first to FIG. 1, a portion of a laundry room 10 of the type found in residential homes is shown. A clothes dryer 12 (only a portion shown) is contained within the laundry room 10. This dryer includes an air outlet 14 through which air, oftentimes entrained with lint, is expelled. Conventionally, the dryer air outlet 14 is 4 inches in diameter.

A dryer docking station or apparatus 16 is also contained within the laundry room 10. This docking station 16 includes a frame 18 which is positioned behind the dryer 12. This frame 18, furthermore, includes a rear portion 20 as well as a front portion.

Still referring to FIG. 1, the rear portion 20 of the frame 18 includes a pair of vertical struts 24 along its sides, a bottom strut 26, and a top strut 28. The struts 24-28 are constructed of a rigid material, such as metal, and are all interconnected together in any conventional fashion so that the rear portion of the frame 20 is generally rectangular in shape. Furthermore, the bottom strut 26 is vertically adjustably secured to the vertical struts 24 by fasteners 27 in order to accommodate an electrical outlet or gas line. This rear portion 20 of the frame 18 is then attached to a wall 30 in the laundry room 10 by fasteners 32.

The front portion 22 of the frame 16 is similar in construction to the rear portion 20 of the frame 18. As such, the front portion 22 of the frame 18 includes a pair of spaced apart and vertically extending struts 34, a top strut 36, and a bottom strut 38. These struts 34-38 are constructed of any conventional rigid material, such as metal, by any conventional means, such as welding. When secured together, the struts 34-38 form a rectangular structure substantially identical in size with the rear portion 20 of the frame 18.

The rear portion 20 and front portion 22 of the frame 18 are connected together by spacers 40 extending between aligned corners of the front portion 22 and rear portion 20 of the frame 18. These spacers 40 are also constructed of a rigid material, such as metal, and secured in between the rear portion 20 and front portion 22 of the frame 18 in any conventional fashion, such as by welding. In doing so, the spacers 40 maintain the rear portion 20 of the frame 18 and front portion 22 of the frame in a spaced apart, aligned, and generally parallel position.

The spacers 40, furthermore, are dimensioned so that a conventional vent pipe 42 for the clothes dryer 12 is contained within the interior of the frame 18. Such vent pipes 42, which may be either rigid pipe or flexible pipe, are typically 4 inches in diameter. Consequently, the spacers 40 space the front portion 22 of the frame 18 forwardly of the wall 40 by 4 or more inches.

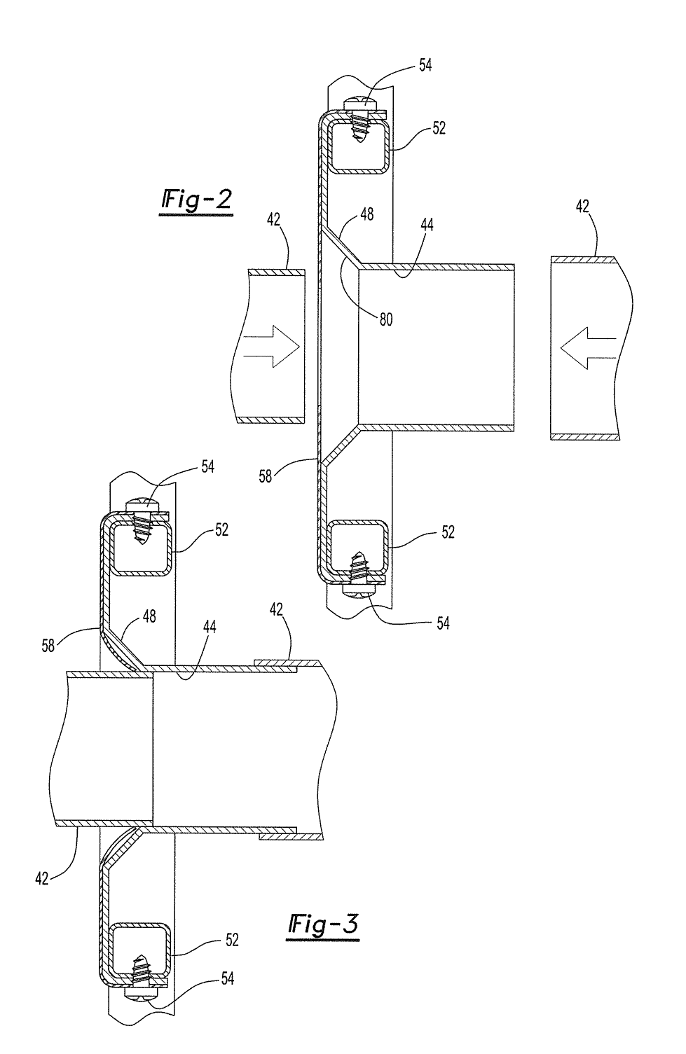

A shelf 70 is mounted by hinges 72 to the top rear strut 28 and movable between an open position, shown in solid line in FIG. 2, and a closed position, shown in phantom line in FIG. 2. In its open position a mirror 74 mounted to the shelf 70 enables an easy visual check behind the dryer for proper vent connection, etc.

Referring now to FIGS. 2 and 3, the vent pipe 42 includes a vent port 44 at its end 46 (FIG. 2) open to the laundry room 10. This vent port 44 is typically a short segment of rigid 4 inch pipe and is dimensioned to be fluidly connected in series with the vent pipe 42 as shown in FIG. 3.

A vent port carrier 48 is horizontally slidably adjustable along the cross bars 52 and, similarly, the cross bars 52 are vertically slidably adjustable along the frame struts 34. Consequently, in order to properly position the vent port carrier 48, the vent port 44 is first aligned with the air outlet 14 from the dryer 12. In this position, fasteners 54 (FIG. 2) are used to secure the vent port carrier 48 to the cross bars 52 and, similarly, fasteners 56 (FIG. 1) are used to secure the cross bars 52 to the frame 18 when the vent port carrier 48 is in its adjusted position. The fasteners 54 and 56 are preferably threaded fasteners, although other fasteners may alternatively be used.

In order to enhance the seal between the dryer air outlet 14 and the vent port 44 for the vent pipe 42, a seal 58 is preferably provided around the vent port 44 for the vent pipe 42. This seal 58 ensures that all of the air exhausted through the dryer air outlet 14 passes into and through the vent pipe 42 and to an outlet 60 for the vent pipe 42. The seal is made of an elastomeric material and also absorbs vibration.

In order to facilitate the connection of the dryer vent pipe 14 to the exhaust flue, the vent port 44 is preferably outwardly flared toward the dryer thus forming a conical surface 80 facing the dryer. This conical surface serves to guide the dryer vent pipe 14 into the outlet flue as the dryer is pushed against the wall.

In operation, the air outlet 14 from the dryer 12 is normally in its connected position as shown in FIG. 3. In its connected position, the air outlet 14 is fluidly connected in series with the vent pipe 42 in the desired fashion.

When access behind the dryer is desired, the dryer 12 is merely pulled away from the docking station 16 thus disconnecting the dryer air outlet 14 from the vent pipe 42. When cleaning or other access to the area behind the dryer is no longer required, the dryer 12 is pushed back against the frame from the position shown in FIG. 2 and to the position shown in FIG. 3. In doing so, since the vent pipe port 44 is automatically aligned with the dryer air outlet 14, the dryer air outlet 14 becomes automatically reconnected to the vent pipe 42 in the desired fashion.

Furthermore, the frame 18 prevents the dryer 12 from crushing or otherwise damaging the vent pipe 42.

From the foregoing, it can be seen that the present invention provides a docking station for a dryer which not only facilitates the connection and disconnection of the air outlet from the dryer to the vent pipe, but also protects the vent pipe 42 from damage. Having described my invention, however, many modifications thereto will become apparent to those skilled in the art to which it pertains without deviation from the spirit of the invention as defined by the scope of the appended claims.

I claim:

1. A dryer docking apparatus comprising:
a frame,
a vent port carrier adjustably secured to said frame, said carrier being vertically adjustable in both a vertical and horizontal direction relative to said frame.

2. The apparatus as defined in claim 1 wherein said frame includes a front portion and a rear portion, said rear portion being spaced from said front portion by an amount sufficient to contain a residential dryer vent pipe.

3. The apparatus as defined in claim 2 wherein said vent port carrier is attached to said front portion of said frame.

4. The apparatus as defined in claim 3 and comprising a seal attached to said vent port carrier.

5. The apparatus as defined in claim 3 wherein said front portion of said frame comprises two spaced apart vertical struts and two spaced apart cross bars extending between said struts, the vent port carrier being secured to said cross bars.

6. The apparatus as defined in claim 5 wherein the vent port carrier is slidably mounted to said cross bars to an adjusted position and locked in said adjusted position by a threaded fastener.

7. The apparatus as defined in claim 6 wherein said threaded fastener is threadably mounted in a hole in said vent port carrier and, upon tightening, abuts against at least one of said cross bars.

8. The apparatus as defined in claim 5 wherein said cross bars are vertically adjustably secured to said vertical struts.

9. The apparatus as defined in claim 8 wherein threaded fasteners secure said cross bars to said vertical struts at a vertically adjusted position by at least one threaded fastener.
